(19) United States
(12) Patent Application Publication
(10) Pub. No.: US 2010/0310309 A1
(43) Pub. Date: Dec. 9, 2010

(54) TERMINUS CAP FOR A DRIVE CABLE, DRIVE CABLE, METHOD FOR THE PRODUCTION OF A TERMINUS CAP, AND METHOD FOR THE PRODUCTION OF DRIVE CABLE

(75) Inventors: Bernd Abendroth, Solms (DE); Klaus Küster, Ehringshausen (DE)

Correspondence Address: CONNOLLY BOVE LODGE & HUTZ, LLP, P O BOX 2207, WILMINGTON, DE, 19899, US

(73) Assignee: Meflex Telecontrol GmbH & Co. KG, Ehringshausen (DE)

(21) Appl. No.: 12/864,169

(22) PCT Filed: Jan. 23, 2009
(86) PCT No.: PCT/EP2009/000445

§ 371 Date: Aug. 24, 2010

(30) Foreign Application Priority Data
Jan. 24, 2008 (DE) 10 2008 005 983.8
May 6, 2008 (DE) 10 2008 022 313.1

(51) Int. Cl. F16C 1/10; B23P 11/00

(52) U.S. Cl. 403/282; 29/505

(57) ABSTRACT

A terminus cap (2; 22; 52; 62) for a drive cable has a connection section (4; 24; 54; 64), which can be cold-formed, on the drive cable, and an end section (6; 26; 56; 66) made of plastic. The connection section (4; 24; 54; 66) has an opening (8; 28; 68) pointing toward the end section (6; 26; 56; 66), and the end section (6; 26; 56; 66) engages partially in the opening (8; 28; 68). An end section (6; 26; 56; 66) of the terminus cap (2; 22; 52; 62) may be fastened on the connection section (4; 24; 54; 64) of the drive cable. The drive cable with terminus cap can be used in pop-up and/or sliding roofs or sunscreen roller blinds of motor vehicles.

### CROSS-REFERENCE TO RELATED APPLICATIONS

This application is a national stage application (under 35 U.S.C. §371) of PCT/EP2009/000445, filed Jan. 23, 2009, which claims benefit of German applications 10 2008 005 983.8, filed Jan. 24, 2008 and 10 2008 022 313.1, filed May 6, 2008.

### TECHNICAL FIELD

The invention relates to an end cap for a drive cable that is used especially in motor vehicles, for example, in sliding and/or tilting sunroofs, or in roller blinds such as, for instance, sun blinds. The invention also relates to a drive cable having such an end cap, as well as to a method for the production of an end cap and to a method for the production of a drive cable.

### BACKGROUND ART

Drive cables or transmission cables of the above-mentioned type are disclosed, for example, in European patent applications EP 0 409 103 A2 and EP 0 181 995 A2. Such drive cables are preferably employed for sliding and/or tilting sunroofs of motor vehicles, whereby the drive cables can usually be axially adjusted by means of a motor-driven screw and whereby the drive cables are attached to a part that is to be adjusted, for example, the sunroof.

Drive cables are usually manufactured as a continuous product made of metal strands consisting of several braids having an applied pitch helix, and they have to be subsequently cut to the required length. The ends of the drive cables created in this process tend to splay because of the loose individual wires of the cable.

Another problem of the prior-art drive cables is that their ends tend to rattle once they have been installed.

In order to solve these problems, a procedure known from the state of the art consists of providing the end of the drive cable with a metal sleeve. This metal sleeve is normally hammered in place. It has been found that this approach can effectively prevent splaying of the end of the drive cable but, because of the metal used, the end of the drive cable still tends to rattle once it has been installed.

In order to remedy the rattling problem encountered with metal sleeves, the alternative approach was put forward to provide a sleeve made of plastic instead of a metal sleeve. Since it is not easy to attach such prefabricated plastic sleeves to the ends of the drive cable by means of mechanical methods, an attempt was made to injection-mold the plastic sleeves directly onto the end of the drive cable. However, it was found that, during the cutting, the ends of the drive cable can acquire very sharp burrs that can damage the injection-molded sleeve. This is why the drive cable has to be polished in order to remove the burrs. This additional work step increases the cost of such drive cables.

Furthermore, it has been found that a directly injection-molded plastic sleeve frequently does not adhere well since it is often the case that oil residues from the production process adhere to the drive cable. For this reason, it must be ensured that at least the ends of the drive cable are free of oil, which can be done by changing the production process of the strands or by performing additional work steps to remove the oil.

Another problem of the injection-molded end sleeves made of plastic is that, due to the requisite high injection-molding pressure, the injection-molded plastic material tends to migrate along the applied pitch helix(es), where it hardens. The plastic material present on the pitch helix can chip off and the chipped material, in turn, can likewise give rise to rattling noises.

German utility model DE 88 10 699 U1 discloses a connecting piece for control cables having a connecting tube to establish a connection to a wire cable and to an injectio n-molded eyelet m ade of hard-elastic plastic affixed thereto, which can be used to operate gears.

German patent application DE 10 2005 006 432 A1 discloses a holding arrangement for lifting and lowering a component, especially a cargo compartment cover of a vehicle having a first holding element that is joined to a pulling element that can be non-positively clamped with a second holding element in such a manner that the clamping connection between the holding elements can be released at a predefined load.

Therefore, it would be desirable to put forward an end cap for a drive cable, a drive cable, a method for the production of an end cap as well as a method for the production of a drive cable, which, taken together, allow an end of the drive cable to be effectively protected against splaying while, at the same time, effectively reducing the tendency of the drive cable to rattle. It would also be desirable to have an end cap and a drive cable that are cost-efficient to produce.

### SUMMARY OF THE INVENTION

According to the first inventive idea, an end cap for a drive cable is provided which can especially be employed in motor vehicles, particularly for sliding and/or tilting sunroofs, or roller blinds, especially sun blinds. The end cap has two sections, namely, a cold-formable connecting section for connecting the end cap to the drive cable, as well as an end section made of plastic adjacent to the connecting section. Therefore, the end section and the connecting section together form the end cap.

The connecting section has an opening facing the end section, whereby the end section preferably partially penetrates the connecting section through the opening, thus allowing a positive connection between the connecting section and the end section. The opening is preferably configured and arranged so as to be radially symmetrical. Attaching the end section to the connecting section is facilitated by such an opening.

Such an end cap makes it possible to effectively and simultaneously safeguard a drive cable from splaying and rattling, whereby the cold-formable connecting section achieves an excellent joining of the end cap to the drive cable since a positive and frictional connection is made between the end cap and the drive cable. The connection can be, for instance, hammered, soldered or crimped. However, the end section made of plastic also reduces the tendency of the drive cable to rattle since plastic is known to be a good sound insulator.

Furthermore, such an end cap can also be cost-effectively produced employing the method according to the invention described below. Another advantage of the end cap according to the invention is that the end of the drive cable created by the cutting does not require a pretreatment such as grinding or degreasing, since the end cap can be easily pulled over the untreated end of the drive cable.

Within the scope of the invention, instead of plastic, the end section can also be made of other materials known from the state of the art that do not tend to rattle very much, for example, natural materials such as cork or rubber and the like, or other materials, e.g. foams, elastomers, etc.

An especially preferred material for the connecting section of the end cap is metal. Metal is particularly easy to process, for instance, by means of deep-drawing, in addition to which it is also inexpensive. Furthermore, metal can be shaped by means of hammering, which facilitates the assembly of the end cap.

Another advantageous embodiment provides that the end section is made of a thermoplastic, for example, polyacetal (POM), polyamide (PA) or polypropylene (PP). Thermoplastics can be processed very well by means of injection-molding methods.

It is likewise preferred for the end cap to be configured so as to be essentially radially symmetrical. In this context, the connecting section as well as the end section can be configured so as to be radially symmetrical and can be attached to each other along a shared axis of symmetry. This facilitates the attachment of the end cap to the drive cable, particularly by means of hammering.

As an alternative, the connecting section, especially the end section, can have radially distributed webs. This can reduce the tendency of the drive cable to rattle and can simplify the installation of the drive cable.

According to another advantageous embodiment, it is provided that the end section is injection-molded onto the connecting section. In this manner, the end cap can be produced very simply and inexpensively, while also ensuring the reliable and dimensionally accurate production of the end cap.

Furthermore, it can be advantageously provided that the connecting section is configured so as to be tapered towards the end section. On the one hand, this allows the end section to be installed on or affixed to the connecting section without the end section circumferentially protruding substantially beyond the diameter of the connecting section, which would cause the end cap to acquire an inconveniently large diameter, and, on the other hand, this allows a particularly secure connection between the connecting section and the end section, even when the connecting section is deformed in order to attach the connecting section to the end of the drive cable.

Preferably, it can be provided that the end cap is configured so as to widen at one end of the connecting section facing away from the end section. This makes it easier to insert the end of the drive cable into the end cap.

According to another advantageous embodiment of the invention, the end section is configured in two pieces, and it is integrally joined to form a one-piece end section when the end cap is assembled. This facilitates the assembly of the end section.

Another embodiment of the end cap according to the invention advantageously provides that the end section is configured so as to be slotted towards the connecting section. This make it very easy to attach the end section to the connecting section in that the end section is inserted into the connecting section and the slotted area of the end section is bent apart and permanently deformed in such a way that a positive connection is created between the end section and the connecting section.

If the end section has a front area and a rear area, whereby the rear area is intended to be inserted into the connecting section, the end section can be better secured in the connecting section if the connecting section has an opening that serves to allow the insertion of the end section and that has a diameter that is smaller than the diameter of the rear part of the end section. This causes the rear part of the end section to be firmly clamped in the connecting section. In this context, a constriction that allows latching can be provided in the rear part of the end section. By hammering the connecting section after insertion of the end section, the bond between the connecting section and the end section can be further improved.

Another aspect of the invention relates to a drive cable that has an end cap in accordance with the invention described above. Such drive cables can be produced cost-effectively, and they combine high quality with a low tendency to rattle.

Another aspect of the invention relates to a method for the production of an end cap in accordance with the invention described above. The method according to the invention provides for the preparation of a connecting section and for the attachment of an end section to the connecting section. An end cap produced according to this method is very sturdy, can be easily and reliably attached to the end of the drive cable, does not tend to rattle and can also be produced cost-effectively.

Particularly advantageously, the end section can be attached to the connecting section by means of insertion, ultrasound welding, thermal upsetting, plastic cold-forming, driving in or by means of direct injection molding. These methods allow a particularly cost-effective production of the end caps while attaining a high level of quality.

Moreover, it can be advantageously provided that the end section and the connecting section are manufactured separately and then clipped together. This translates into a particularly easy assembly.

Furthermore, it can be provided that the end section and the connecting section are manufactured separately and that the end section is then latched into the connecting section. This accounts for a particularly easy attachment of the end section in the connecting section.

According to a last aspect of the invention, a method for the production of a drive cable is provided that is especially used in motor vehicles, particularly for sliding and/or tilting sunroofs, or roller blinds, especially sun blinds. In the method according to the invention, a cable section is provided and an end cap that is configured in accordance with the above-mentioned invention is attached to one end of the drive cable. This method can be executed particularly easily and allows the production of particularly high-grade drive cables.

An advantageous embodiment of the method according to the invention provides that the end cap is attached to the end of the drive cable by means of hammering. In comparison to other conceivable means of attachment, hammering is easy to carry out and ensures a reliable connection of the connecting cap to the end of the drive cable.

Advantageously, the connecting section is attached to the end of the drive cable and the end section is injection-molded onto the already attached connecting section. This allows production with very few rejects since the connecting section has already acquired its final shape before the end section is attached by means of injection-molding. Otherwise, it can happen in rare cases that the deformation of the end section causes the end section to break off, especially if the end cap has not been properly inserted into the hammering device.

Additional objectives, advantages, features and application possibilities of the present invention ensue from the description below of an embodiment on the basis of the drawings. In this context, all of the described and/or depicted features, either on their own or in any meaningful combination, constitute the subject matter of the present invention, also irrespective of their compilation in the claims to which they refer back.

### BRIEF DESCRIPTION OF THE DRAWINGS

The following is schematically shown:

FIG. 1 an end cap according to the invention;

FIG. 2 a cross section through the end cap from FIG. 1 along the sectional line A-A;

FIG. 3 a cross section through an alternative embodiment of the end cap according to the invention;

FIG. 4 an end section of an end cap according to the invention;

FIG. 5 a third embodiment of an end cap according to the invention;

FIGS. 6a to 6c a drive cable having a conventional metal sleeve in a top view (FIG. 6A), in a cross section (FIG. 6B) through a drive cable, as well as in a cross section through a prior-art sleeve (FIG. 6C);

FIG. 7 a drive cable according to the state of the art, with an injection-molded end section, as well as

FIGS. 8A,B a fourth embodiment of an end cap according to the invention.

### DETAILED DESCRIPTION OF EMBODIMENTS

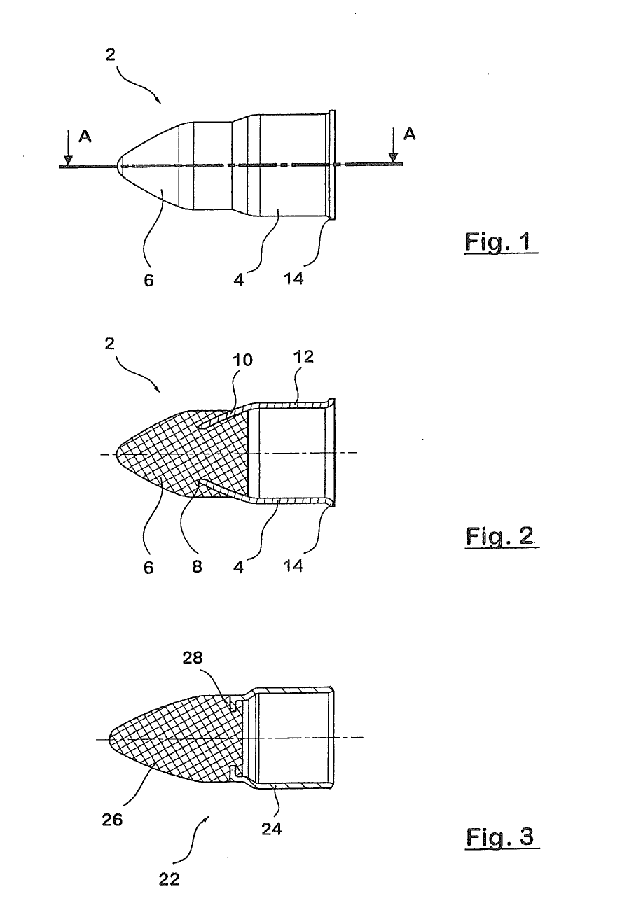

FIG. 1 shows an end cap 2 according to the invention, comprising a connecting section 4 as well as an end section 6. The end cap 2 according to the invention is configured so as to be essentially rotationally symmetrical and tapers gradually towards the side facing away from the drive cable.

The connecting section 4 is made of metal that is easy to cold-form. The connecting section 4 serves to allow the insertion of an end of the drive cable (not shown here) into the end cap 2 and to fasten the end cap 2 onto the end of the drive cable. The visible part of the connecting section 4 is configured so as to be primarily cylindrical, as a result of which the connecting section 4 can be properly fastened, for instance, by being hammered onto the end of the drive cable.

The end section 6 is made of plastic and it is configured with a round tip so as to taper conically in the front end, thus facilitating the installation of a drive cable that is provided with such an end cap 2.

FIG. 2 shows a cross section through an end cap 2 according to the invention, along the sectional line A-A from FIG. 1.

Towards the end section 6, the connecting section 4 has an opening 8 that is configured so as to be essentially circular and axially symmetrical. The connecting section 4 has a front area 10 that is tapered towards the front with respect to the diameter of an essentially cylindrical rear section 12. The opening 8 and the tapering front area 10 make it possible that the end section 6 is merely bent and not sheared when the connecting section 4 is hammered so that the end cap 2 can be attached to the drive cable. The deformation of the connecting section 4 takes place over the entire connecting section 4 and causes compression of the front area 10 that has not been hammered. As a result, the reject rate during the attachment of the end caps 2 onto the cables can be reduced since the plastic of the end area 6 has more of a tendency to rupture than to be deformed when exposed to shear forces.

The connecting section 4 has a widened area 14 at the end facing the cable, facilitating the insertion of the drive cable into the connecting section 4.

In the embodiments shown in FIGS. 1 and 2, the connecting section 4 and the end section 6 can be joined to each other by means of various methods. One possibility is to directly injection-mold the plastic onto the connecting element 4 that has already been produced, for instance, by means of deep-drawing. For this purpose, the connecting element 4 is placed onto a punch and then injection-molded with the thermoplastic from the top through the opening 8, so that the plastic assumes the shape of the end section 6 during the forming procedure and, at the same time, a reliable, positive connection is always attained, irrespective of any possible tolerances of the connecting section 4.

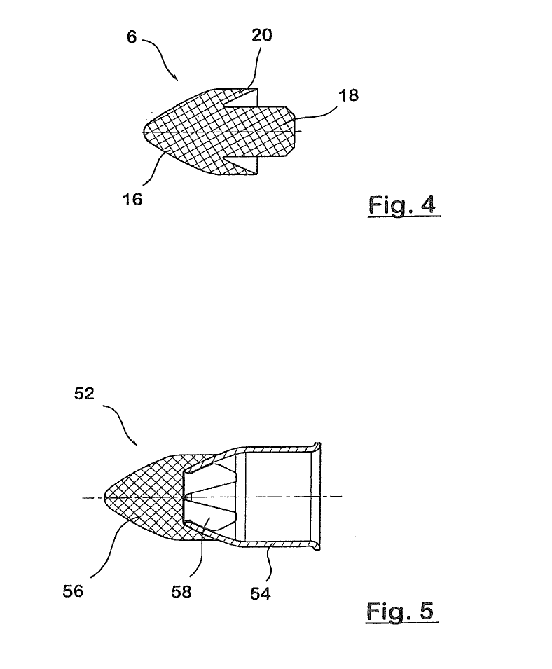

Other possibilities are explained on the basis of FIG. 4 in conjunction with separately prefabricated end sections 6 made of plastic or the like.

FIG. 3 shows a cross-sectional view of an alternative embodiment to the embodiment depicted in FIGS. 1 and 2. The end cap 22 has a connecting section 24 as well as an end section 26, whereby the connecting section 24 is not configured so as to be conically tapered towards the front in the area facing the end section as was the case with the embodiment first described, but rather, it is configured so as to be continuously cylindrical and to have a collar that protrudes into the end section 26 and that has a circular opening 28. The end section 26 is injection-molded directly onto the connecting section 24.

FIG. 4 shows a conceivable embodiment of the end section 6 of the kind that can be used for the first variant (FIGS. 1, 2) if the end section 6 is going to be prefabricated separately.

The end section 6 comprises a front conical area 16 and a rear cylindrical area 18. The front area 16 widens to a diameter that is greater than the diameter of the rear area 18 and it makes the transition to the rear area 18 with an undercut 20. This undercut 20 has essentially the contour of the tapered area 10 of the associated connecting element 4. The end section 6 can then be inserted into the opening 8 of the connecting element and can subsequently be permanently deformed in order to create a positive connection with the connecting section. The deformation of the rear area 18 can be carried out by means of ultrasound welding, thermal upsetting, riveting or cold-forming employing a punch.

FIG. 5 shows another alternative of an end cap 52 according to the invention. In contrast to the first embodiment shown in FIGS. 1 and 2, a front end section 56 that is injection-molded onto a connecting section 54 is positively fastened by means of a slotted and shaped rear area 58. In this embodiment, the end section 56 can be joined to the connecting section 54 by clipping them together.

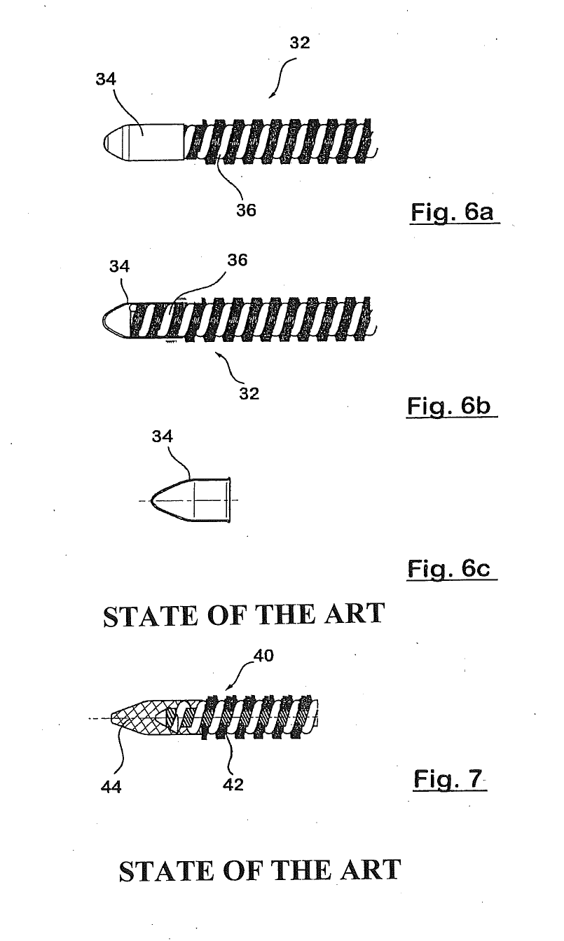

FIGS. 6a to 6c show a drive cable 32 known from the state of the art. FIG. 6a depicts a side view of the drive cable 32. The drive cable 32 is closed on its front end by a sleeve 34 in order to prevent the drive cable 36 from splaying. The prior-art sleeve 34 is made of metal and is fastened to the end of the drive cable 36 by means of hammering.

FIG. 6b shows a cross section through the cable from FIG. 6a. The end of the drive cable 32 protrudes into the end cap 34 all the way to the conically tapered area of the end cap 34.

FIG. 6c shows a cross section of the end cap 34 known from the state of the art. The end cap 34 is configured so as to be conically tapered towards the front. Such end caps can be produced, for example, by means of the deep-drawing method.

FIG. 7 shows another possibility known from the state of the art for purposes of capping a drive cable. A plastic cap 44 is injection-molded directly onto the end 42 of the cable. For this purpose, the end 42 of the drive cable has to be pre-treated, particularly de-burred; if applicable, it might also be necessary to carry out a cleaning and/or degreasing procedure.

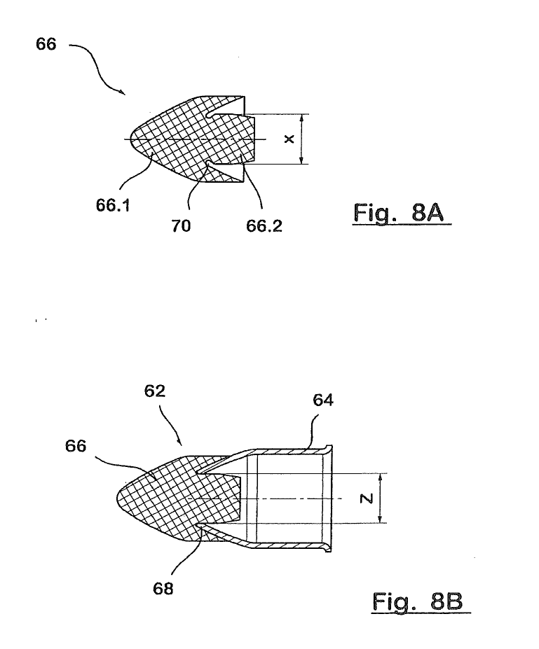

FIG. 8A shows an end section 66 of an end cap according to a fourth embodiment. The end section 66 has a front section 66.1 as well as a rear section 66.2 that is inserted into a connecting section 64 shown in FIG. 8B into an opening 68 provided for this purpose.

The opening 68 of the connecting section 64 has a diameter Z that is smaller than the largest diameter X of the end section 66.2. During the insertion, it can be achieved here that the end section 66 fits securely in the opening 68 of the connecting section 64 provided for this purpose, so that it cannot fall out. In the fourth embodiment, the assembly can be carried out by a simple insertion. The secure fit can be additionally improved by hammering the connecting section 64 after the end section 66 has been inserted, as a result of which the diameter Z of the opening 68 of the connecting section 64 is further reduced in the manner described above, thus achieving an additional clamping effect.

Of course, the appertaining components do not have to be configured so as to be radially symmetrical. They can also have different shapes such as, for example, oval, angular or the like. This is easily determined within the scope of the concrete requirements.

The rear section 66.2 of the end section 66 can have a constriction 70 towards the front section 66.1, thus improving the secure fit of the end section 66 in the connecting section 64. The end section 66 then latches into the connecting section 64. For this purpose, the constriction 70 has a diameter that corresponds approximately to the diameter Z of the opening 68 of the connecting section 64, or that is even somewhat smaller than that of diameter Z. Such a constriction 70, however, is not absolutely necessary for the fourth embodiment.

While preferred embodiments of the invention have been described and illustrated here, various changes, substitutions and modifications to the described embodiments will become apparent to those of ordinary skill in the art without thereby departing from the scope and spirit of the invention.

### LIST OF REFERENCE NUMERALS

2 end cap
4 connecting section
6 end section
8 opening
10 front area of the connecting section 4
12 rear area of the connecting section 4
14 widened area
16 front area of the end section 6
18 rear area of the end section 6
20 undercut
22 end cap
24 connecting section
26 end section
28 opening
32 drive cable
34 sleeve
36 end of the drive cable
40 drive cable
42 end of the drive cable
44 plastic cap
52 end cap
54 connecting section
56 end section
58 slotted rear area
62 end cap
64 connecting section
66 end section
66.1 front section
66.2 rear section
68 opening
70 constriction
x diameter of the end section
z diameter of the connecting section

1.-20. (canceled)

21. An end cap for a drive cable for sliding and/or tilting sunroofs or sun blinds of motor vehicles, comprising:
an end section made of plastic; and
a connecting section that is connected to the drive cable by cold-forming with metal braids of the drive cable;
wherein the connecting section defines an opening facing the end section, and the end section engages partially into the opening.

22. The end cap according to claim 20, wherein the connecting section is made of metal or of a cold-formable plastic.

23. The end cap according to claim 20, wherein the end section is made of a thermoplastic selected from the group consisting of: polyacetal (POM), polyamide (PA), polypropylene (PP), and mixtures.

24. The end cap according to claim 20, wherein the connecting section is essentially radially symmetrical.

25. The end cap according to claim 20, wherein the opening is radially symmetrical.

26. The end cap according to claim 20, wherein the end section is injection-molded onto the connecting section.

27. The end cap according to claim 20, wherein the connecting section tapers toward the end section.

28. The end cap according to claim 20, wherein the connecting section widens at its end facing away from the end section.

29. The end cap according to claim 20, wherein the end section is configured in two pieces.

30. The end cap according to claim 20, wherein the end section defines a slotted area.

31. The end cap according to claim 20, wherein the end section has a rear area with a diameter that is greater than a diameter of an opening of the connecting section.

32. The end cap according to claim 31, wherein the rear area of the end section has a constriction towards a front area of the end section, and the diameter of said constriction is smaller than or equal to the diameter of the opening of the connecting section.

33. The end cap according to claim 20, characterized in that the connecting section is made of a thermoplastic.

34. A method for making a drive cable with an end cap for use in sliding and/or tilting sunroofs, or sun blinds of motor vehicles, comprising:
attaching an end section formed of plastic to a connecting section to form the end cap, wherein the connecting section defines an opening facing the end section, and the end section engages partially into the opening; and
hammering the end cap to one end of the drive cable.

35. The method according to claim 34, wherein the end section is attached to the connecting section using joining means selected from the group consisting of: insertion, ultrasound welding, thermal upsetting, plastic cold-forming, driving in, and direct injection molding.

36. The method according to claim 34, wherein the end section and the connecting section are manufactured separately, and the end section and the connecting section are clipped together.

37. The method according to claim 34, wherein the connecting section is hammered to the one end of the drive cable and the end section is injection-molded onto the already attached connecting section.

38. The method according to claim 34, wherein the end section is pressed for latch engagement into the connecting section.
